(19) United States
(12) Patent Application Publication
(10) Pub. No.: US 2026/0328178 A1
(43) Pub. Date: Oct. 22, 2026

(54) Blade Element Comprising Channel and Vane for Use in Ocean Current Turbine

(71) Applicant: RANDSEA AS, Skallestad (NO)

(72) Inventor: Arill Fagereng, Skallestad (NO)

(21) Appl. No.: 19/111,350

(22) PCT Filed: Sep. 15, 2023
(86) PCT No.: PCT/NO2023/060048

§ 371 Date: Mar. 13, 2025

(30) Foreign Application Priority Data
Sep. 16, 2022 (NO) 20220990

(51) Int. Cl. F03B 17/06; F03B 3/12

(52) U.S. Cl. CPC F03B 17/06; F03B 3/121

(57) ABSTRACT

A blade element arranged for use in an ocean current turbine comprising the following features:
an axially arranged inlet channel having a central axis and arranged to face upstream with an upstream channel opening in its operating state, and
with at least one axially arranged vane, with an upstream vane opening disposed within a downstream channel opening,
an axially arranged main body having an upstream surface, disposed within a downstream vane opening, and having a rotationally symmetrical section having one or more convex surfaces extending from the upstream surface beyond the downstream vane opening and toward an axially arranged downstream end of the axially arranged main body.

### BACKGROUND

The disclosed embodiments relate to the blade elements of an ocean current turbine having a main frame with bow, continuously convex frame sides and a straight truncated or pointed aft section. The shape of the main frame is approximately drop-shaped in the horizontal plane. Along the continuous convex frame sides there are provided vane elements secured via rails, preferably on the outside of the main frame itself of the ocean current turbine, wherein the vane element comprises an inlet channel, arranged upstream of the ocean current, and a blade arranged in a gap opening between the inlet channel and the main body of the vane element itself. In which the main body preferably comprises a flat upstream surface, which is circular or rectangular, and with corresponding hemispherical or conical part towards a downstream end. The blade elements, which are arranged on endless rotation chains, are pushed backwards from bow and towards the aft section of the main frame by means of the ocean current. At the aft section, the blade element is rotated approximately 180 degrees and is pulled upwards towards the bow again, the pulling force then comes from the vane elements pushed backwards from the bow by the ocean current. When the blade element returns to the bow, the blade element is rotated approximately 180 degrees left, so that the inlet channel is again upstream and can be pulled backwards by the ocean current. The rotating chain runs around and engages with one or more drive wheels that drive one or more generators, preferably through one or more gears, so that the ocean current turbine converts the kinetic energy (kinetic energy) of the ocean current into electrical energy.

There is currently a great need for energy that does not cause any additional carbon emissions to the atmosphere. Wind power is a source where utilization increases with time, while water flow (ocean current, tidal current, wave current), which is a huge source of energy, is almost unused to date. Being able to generate electrical energy from the kinetic energy (kinetic energy) of the ocean current will be important in further reducing environmentally harmful emissions to the atmosphere. There are large ocean currents that contain enormous amounts, more or less constant, kinetic energy, such as for example, the Gulf Stream. The Gulf Stream maintains a more or less constant speed of up to 9 km/h in certain places, which may not seem like much, but taking into account that the Gulf Stream carries about 40 million cubic meters of water every second, then there will be great forces at work. The ability to convert such energy sources into electrical energy is the background of the inventive embodiments disclosed herein.

Ocean current turbine technology must be built to withstand the violent forces that can occur underwater. The conventional bottom-placed ocean current turbines, also known as sea mills, must also be far enough underwater that they do not get in the way of boat traffic and deep-sea fishing. At the same time, they must not be far from land, because the electricity must be transported to civilization via cables. If the turbines are in the middle of the ocean, long power cables must be made and a lot of energy will be lost during transport. All this makes the turbines very expensive, and greatly limits where the turbines can be placed.

Co-owned and co-invented WO2017213518 (A1) ('518 publication) concerns an ocean current turbine that is sharply V-shaped with a tip against the current, two straight frame sides with linearly increasing distance based on the distance from the tip, and with a wide aft section. On the starboard and port sides of the V-shaped main frame, main chains with transverse plates run, which are captured by the water current. The main chain drives a wheel connected to a generator to convert kinetic energy into, for example, electrical energy. From the rear end at the widest point, the plates are rotated from transverse to longitudinal, and the main chain returns in a shielded space between the frame sides with the plates directed along the main chain.

Co-owned and co-invented WO2020046134 (A1) is a further development of the disclosed embodiments of the '518 publication, where the ocean current turbine has now taken on a boat-like shape, with a bow section facing the water current and a broader midsection extending towards a narrower, straight transverse aft section. On the starboard and port sides, there are endless chains, each equipped with transverse plates that run from the bow section to the aft section, powered by the water current. At the aft section, there is a turning mechanism that turns the plates into a passive position, before they are returned by the endless chain back to the bow where they are again turned into an active position and moved afterwards by the ocean current.

### SUMMARY

The disclosed embodiments are generally aimed at solving at least one, but preferably several, of the problems existing with the prior technology. More particularly, the disclosed embodiments provide an ocean current turbine with more efficient vane elements. Also provided are blade elements that can be placed in a row, with reduced turbulence for the next blade element. Also provided are embodiments for placement of the blade elements on the ocean current turbine itself so that they maximize the effectiveness of how the water current impacts the blade elements. Also provided is an ocean current turbine that is bowed up against the water current and has a design that provides a good water flow rate along the sides of the ocean current turbine where the vane elements are positioned to be driven afterwards by the water current.

Disclosed herein is a blade element adapted for use in an ocean current turbine comprising the following features:
An axially arranged inlet channel with a central axis designed to face upstream with an upstream channel opening in its operational state; and
With at least one axially arranged vane, having an upstream vane opening arranged within a downstream channel opening.
An axially arranged main body with an upstream surface, located within the downstream vane opening, and with a rotationally symmetric portion having one or more convex surfaces extending from the upstream surface and passing the downstream vane opening towards an axially arranged downstream end on the main body.

The embodiments relate to the design of a blade element for use on an ocean current turbine so as to reduce turbulence after the blade element while maintaining the driving force (drag force). The embodiments also allows the reversing mechanism at the bow and aft section to be only a normal driving wheel, as the blade element naturally turns to its correct operating state by following the rotation of the endless chain in the bow and aft section connected to the driving wheels.

### BRIEF DESCRIPTION OF THE DRAWINGS

Preferred embodiments of the invention will hereinafter be discussed in more detail with reference to the accompanying figures, wherein:

FIG. 1 shows an embodiment in which an ocean current turbine 0 is fully equipped to stand in a water stream F and deliver renewable energy.

FIG. 2 shows an embodiment of an ocean current turbine 0 seen from above, without mounted equipment as shown in FIG. 1, where an embodiment is shown with the blade elements on the outside of the starboard and port side frame SS, BP.

FIGS. 3A and 3B show an embodiment of a blade element 10.0 with a circular design of an upstream surface 13.1 designed for use in an ocean current turbine 1.0.

FIG. 4 shows an embodiment of a blade element 10.0 with a circular design of an upstream surface 13.1, where it is indicated that the water current F attacks against the circular design of an upstream channel opening 11.1.

FIGS. 5A and 5B show an embodiment of a blade element 10.0 with rectangular configuration of an upstream surface 13.1 adapted for use in an ocean current turbine 1.0.

FIG. 6 shows an embodiment of a blade element 10.0 with rectangular configuration of an upstream surface 13.1, where it is indicated that the water flow F is attacking an upstream channel opening 11.1 consisting of two vertical plates.

FIG. 7 shows an embodiment of two venturi 30.0 ejectors arranged in a blade element 10.0 of a rectangular configuration

FIGS. 8A-8C show a software simulated turbulence situation of 3 embodiments of a blade element 10.0.

FIGS. 9A and 9B show a software simulated turbulence situation with 3 blade elements 10.0 arranged one after the other.

### DETAILED DESCRIPTION

Provided herein is a blade element adapted for use in an ocean current turbine comprising the following features:
An axially arranged inlet channel with a central axis designed to face upstream with an upstream channel opening in its operational state; and
With at least one axially arranged vane, having an upstream vane opening arranged within a downstream channel opening.
An axially arranged main body with an upstream surface, located within the downstream vane opening, and with a rotationally symmetric portion having one or more convex surfaces extending from the upstream surface and passing the downstream vane opening towards an axially arranged downstream end on the main body.

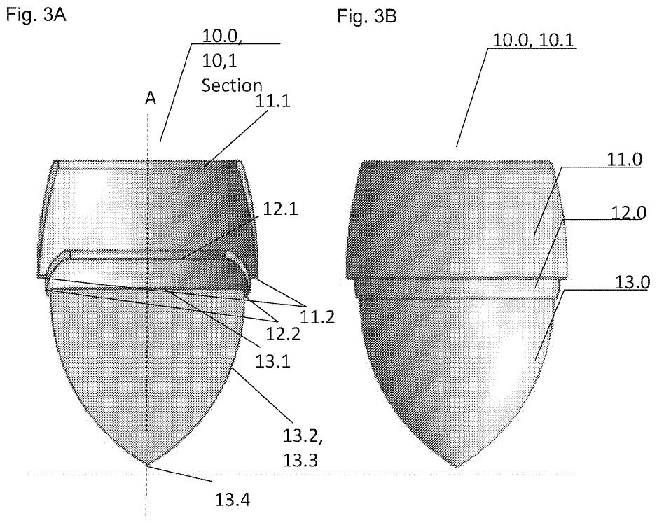

The term axially arranged shall be interpreted as shown in FIGS. 3A-6 with a major axis A. The main axis A runs through the blade element so that the parts from which the blade element is constructed are arranged axially with the main axis A.

In an embodiment of the invention, the one or more convex surfaces are straight and/or purely planar converging surfaces, even though such surfaces do not yield as good results as the one or more convex surfaces in the simulation model, it might appear differently in practice.

In an embodiment of the invention, the main body is hollow, so that the upstream surface consists mainly of a body of water.

In an embodiment of the invention, the axially arranged inlet channel on the blade element is an axially arranged inlet sleeve, and the at least one axially arranged blade is a blade sleeve, and the axially arranged main body is a circular upstream surface.

In another embodiment of the invention, the axially arranged inlet channel of the blade element comprises at least two lateral surfaces which are arranged in pairs and symmetrically about the central axis and to the side of the main body of the blade element, and the axially arranged main body has a rectangular upstream surface.

In an embodiment of the invention, the at least one vane has a cross-sectional shape resembling an airfoil profile, and the cross-sectional shape is arranged with its convex main surface arranged outward in relation to the central axis, with its trailing edge positioned at the downstream blade opening.

In an embodiment of the invention, the at least one vane is arranged with a gap opening towards the axially arranged main body. So that the Coanda effect is formed over the main body along the convex surface between the upstream surface towards the downstream end. This results in less turbulence and flow directed to the next blade element. This also results in a higher fluid velocity along the convex surface, which in turn leads to lower pressure perpendicular to the convex surface, creating a suction effect. Due to the geometry, this suction effect acts as a driving force on the blade element.

In an embodiment of the invention, the blade element has an overall length of between 5 and 25 meters, preferably between 10 and 20 meters, and more preferably between 12 and 18 meters.

In an embodiment of the invention, one or more venturi ejectors are axially arranged in the main body such that a venturi nozzle has an inlet in the upstream surface and a venturi diffuser has an outlet in the downstream end, and wherein the venturi intake sucks in air or water. The suction may be lateral to the central axis. It has been observed in the modelling that it gives a better effect when using one or more venturi ejectors in the blade element and we do not wish to speculate or give an explanation as to why it gives a better effect.

In an embodiment of the invention, the ocean current turbine that converts water flow energy comprises two or more blade elements, further comprising the following features:
a main frame adapted to be wholly or partially immersed in a current of water in the sea or in a river,
where the main frame comprises
a bow portion adapted to face substantially the flow of water,
starboard and port endless rotation chains with blade elements arranged to be caught at the bow portion and driven rearward by the water current,
where the rotation chain runs about and in driving engagement with one or more driven wheels driving a generator, and
port and starboard side frames that are continuously convex and that extend from the bow section and rear to
a transverse or pointed aft section narrower than the greatest distance between port and starboard side frames,
where each of the endless rotation chains is provided with the blade elements, arranged to run along the port and starboard side frames.

In a further embodiment of the invention, where the ocean current turbine has the rotation chains supported by a starboard and port rotation rail on the respective starboard and port side of the main frame, so that the blade elements are propelled backward by the water current alongside the main frame.

In an embodiment of the invention, the ocean current turbine has the main frame that includes at least one vertical port bow blade and at least one vertical starboard blade designed with airfoil profiles, and the cross-sectional shape is arranged with its convex main surface facing outward from the bow section and with its trailing edge positioned downstream toward the respective starboard and port endless rotation chain.

In an embodiment of the invention, the ocean current turbine has at least three blade elements arranged in a row, one after the other, on the starboard and on the port endless rotation chain, respectively.

In an embodiment of the invention, the offshore power turbine generators generate hydrogen, so that the energy converted to hydrogen can be stored in tanks and retrieved by ships for transportation to shore.

In an embodiment of the invention, the blade element can be ballasted (change its weight) in water, either manually or automatically, allowing for the adjustment of the weight of the blade element. It is advantageous to be able to reduce the vertical forces transmitted to the starboard and port rotary rails of the ocean current turbine.

Preferred embodiments will hereinafter be discussed in more detail with reference to the accompanying figures.

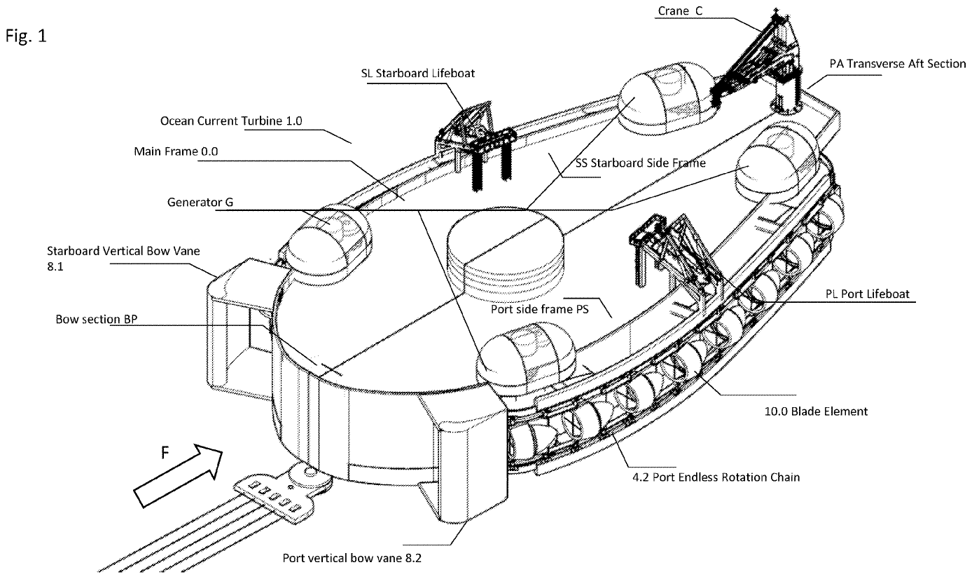

FIG. 1 shows an embodiment in which an ocean current turbine (1.0) comprises a main frame (0.0) comprising substantially a starboard and a port side frame (SS, BS). The main frame (0.0) further comprises a bow portion (BP) and a transverse aft section (PA). While not shown in the Figure, the aft section may also be pointed. FIG. 1 shows the main frame with equipment such as a crane (K) and a port lifeboat (BL) and a starboard lifeboat (SL), showing that this comprises a semi-submersible ocean current turbine (0.0). An ocean current turbine (1.0) may also be fully submersible. Furthermore, FIG. 1 shows a way in which the ocean current turbine (0.0) is stored in a storage device in the bow section (BP), with a swivel in the horizontal plane, so that the bow section (BP) will be adjusted towards the direction of the water flow (F) towards the ocean current turbine (1.0). FIG. 1 is a bird's-eye view viewed obliquely from the front towards the port side of the ocean current turbine, and further shows the blade elements arranged on the port endless rotation chain. At the forefront, that is, at the bow section (BP), it appears two vertical bow vanes, one starboard and one port, (8.1, 8.2), are positioned at the beginning of the endless rotation chains (4.1, 4.2) on the respective starboard and port sides of the ocean current turbine. On the main deck of the ocean current turbine (1.0), where the crane (K) and starboard and port lifeboats (SL, BL) are mounted, there are also four generators (G) shown, which are connected via drive wheels that engage with the endless rotation chains (4.1, 4.2).

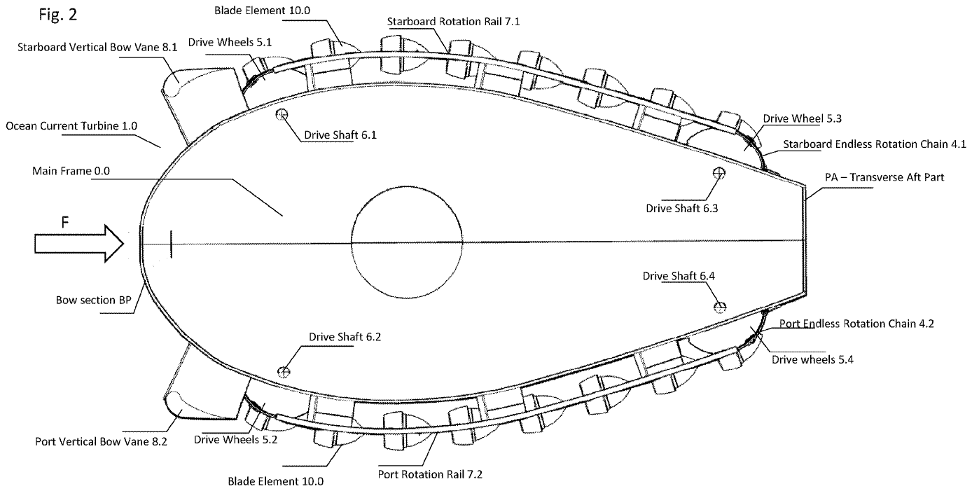

FIG. 2 shows an embodiment in which an ocean current turbine (1.0) is shown from above and in which a bow portion is directed towards a water flow (F) with a transverse aft section (PA) at the opposite end. FIG. 2 further shows how the port and starboard vertical bow vanes (8.1, 8.2) are arranged ahead of the endless rotation chains (4.1, 4.2) on the starboard and port sides, respectively, and how the endless rotation chains (4.1, 4.2) are provided with blade elements (10.0) and further arranged around and engage the drive wheels (5.1, 5.2, 5.3, 5.4) so that the drive shafts (6.1, 6.2, 6.3, 6.4) can further drive the generator (G), as shown in FIG. 1, directly or via one or more gears.

FIGS. 3A and 3B show an embodiment of the invention, wherein FIG. 3A shows a longitudinal section of the blade element (10.0) and FIG. 3B shows the blade element (10.0) comprising an axially arranged inlet channel (11.0), an axially arranged vane (12.0) and an axially arranged main body (13.0). FIG. 3A shows an embodiment of the blade element section, comprising a longitudinal axis (A), an upstream channel opening (11.1) as an upstream sleeve opening, a downstream channel opening (11.2) as a downstream sleeve opening, an upstream vane opening (12.1), a downstream vane opening (12.2), an upstream surface (13.1) as a circular embodiment, a rotationally symmetrical section (13.2), a convex surface (13.3) and an axially arranged downstream end (13.4). FIG. 3A shows an embodiment in which the upstream vane opening (12.1) is arranged with the downstream channel opening (11.2) and further that the downstream channel opening (11.2) forms a gap opening between the axially arranged inlet channel (11.0) and the axially arranged vane (12.0). FIGS. 3A and 3B show an embodiment wherein the upstream surface (13.1) having a circular configuration. The rotationally symmetrical section (13.2) will have a convex surface (13.3) formed as a cone with a terminating axially arranged downstream end (13.4). It is not apparent from FIGS. 3A and 3B how the axially arranged inlet channel (11.0), the axially arranged vane (12.0) and the axially arranged main body (13.0) are interconnected. The interconnection depends on the type of material the blade element (10.0) is made of, and if, for example, it is plastic-molded, it may be necessary to use more stiffeners and brackets than if it is designed in aluminium or steel. Carbon fiber or titanium may be alternative material choices, which require suitable adaptations of stiffeners and brackets based on geometry and calculations. It is possibly that the three elements:
1. the axially arranged inlet channel (11.0),
2. the axially arranged vane (12.0)
3. the axially arranged main body (13.0)
   in the blade element (10.0) are assembled using at least two, and preferably four brackets in the openings between 1 and 2, and between 2 and 3. It is also possible that the upstream channel opening (11.1) has one or more vertical and horizontal stiffeners. The same can be considered for the upstream vane opening (12.1), which may have one or more vertical and horizontal stiffeners. The axially arranged main body (13.0) may also be hollow, such that the upstream surface (13.1) consists of substantially a body of water (not shown in the figure).

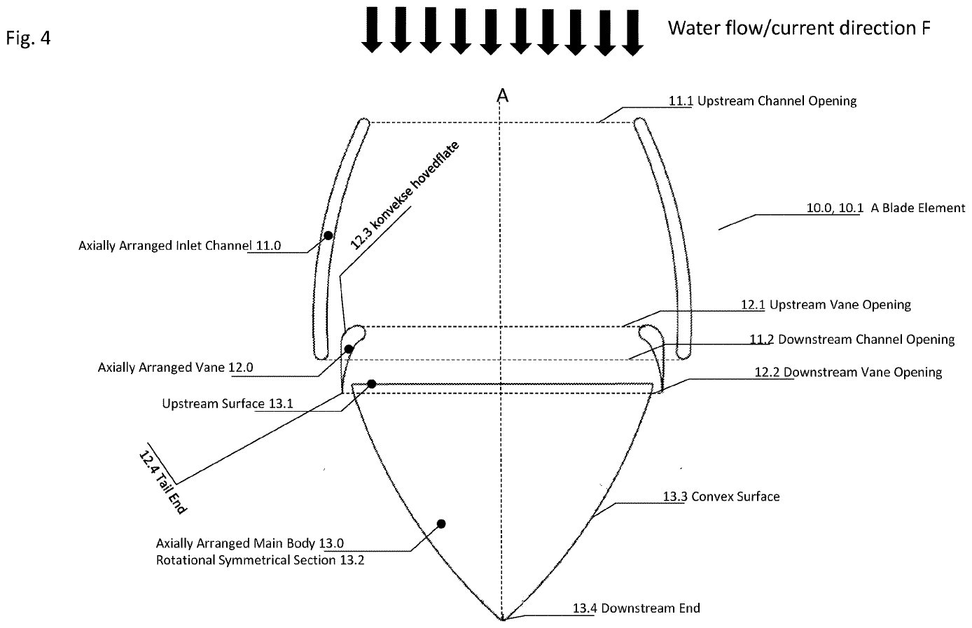

FIG. 4 shows an embodiment of a blade element (10), in a cross-section against a water current direction (F). FIG. 4 shows an axially arranged inlet channel (11.0), as an axially arranged inlet sleeve, with an upstream channel opening (11.1) as an upstream sleeve opening, and a downstream channel opening (11.2) as a downstream sleeve opening. FIG. 4 further shows an axially arranged vane (12.0), which is one shaped as a ring/sleeve (not evident from the figure, but if the inlet channel is a sleeve, then the vane will also be circular), provided with its upstream vane opening (12.1) inside the downstream channel opening (11.2) and with its downstream vane opening (12.2) located outside the downstream channel opening (11.2), where a gap opening is provided between the axially arranged inlet channel (11.0) and the axially arranged vane (12.0), so that part of the water flow (F) can flow out between the downstream channel opening (11.2) and the axially arranged vane (12.0) for the three main elements, blade element (10.0, 10.1), overlaps the axially arranged vane (12.0), which in turn overlaps the axially arranged main body (13.0). FIG. 4 shows an embodiment of the axially arranged vane (12.0) with a convex main surface (12.3) pointing outwardly from a longitudinal axis (A) and towards the axially arranged inlet channel (11.0) and wherein the axially arranged vane has a tail end (12.4) so that the axially arranged vane (12.0) has a cross-sectional profile like an airfoil. Furthermore, FIG. 4 shows an axially arranged main body (13.0) with an upstream surface (13.1), which here is circular, and which is arranged within the downstream vane opening (12.2), so that a gap is formed between the axially arranged vane (12.0) and the axially arranged main body (13.0) in order for part of the water flow (F) to flow through. FIG. 4 shows the axially arranged main body (13.0) designed with a convex surface (13.3) extending from the upstream surface (13.1) to an axially arranged downstream end (13.4). Further, FIG. 4 shows the axially arranged main body (13.0) as a rotationally symmetrical section (13.2), and in this embodiment with circular upstream surface (13.1).

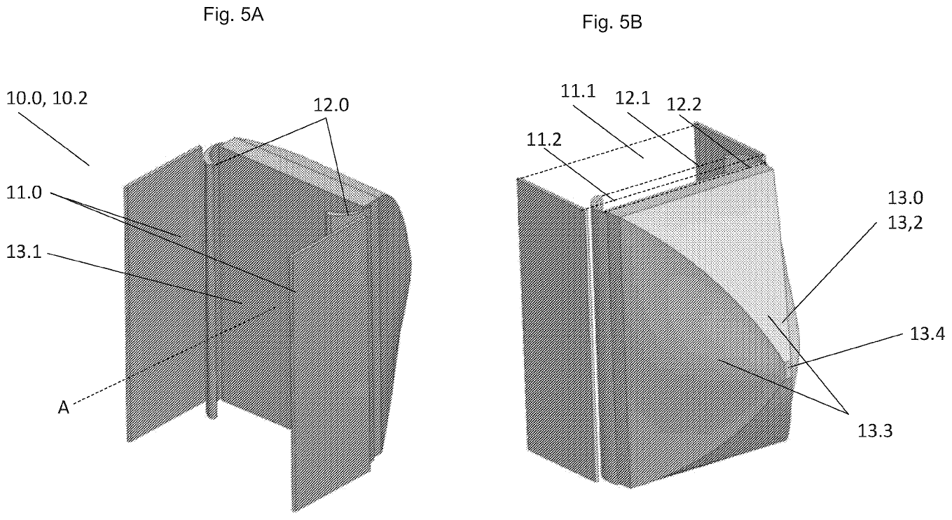

FIGS. 5A and 5B show an embodiment, wherein FIG. 5A shows the blade element (10.0) viewed obliquely from the front and FIG. 5B shows the blade element (10.0) obliquely from the rear comprising an axially arranged inlet channel (11.0), two axially arranged vanes (12.0) and an axially arranged main body (13.0).

FIG. 5A shows an embodiment of the blade element (10.0), comprising a longitudinal axis (A), an axially arranged inlet channel (11.0) comprising two axially arranged plates, an upstream surface (13.1).

FIGS. 5A and 5B show an embodiment of the invention comprising the upstream surface (13.1) having a rectangular configuration. The rotationally symmetrical section (13.2) will have 4 convex surfaces (13.3) formed as a convex pyramid with a terminating axially arranged downstream end (13.4). It is not apparent from FIGS. 5A and 5B how the axially arranged inlet channel (11.0), the axially arranged vane (12.0) and the axially arranged main body (13.0) are interconnected.

The interconnection depends on the type of material the blade element (10.0) is made of, and if, for example, it is plastic-molded, it may be necessary to use more stiffeners and brackets than if it is designed in aluminium or steel. Carbon fiber or titanium may be other relevant material choices, which will require suitable adaptations of stiffeners and brackets based on geometry and calculations. It is possibly that the three elements:
1. the axially arranged inlet channel (11.0),
2. the axially arranged vane (12.0)
3. the axially arranged main body (13.0)
   in the blade element (10.0) are assembled using at least two, and preferably four brackets in the openings between 1 and 2, and between 2 and 3. It is also possible that the upstream channel opening (11.1) has one or more vertical and horizontal stiffeners. The same can be considered for the upstream vane opening (12.1), which may have one or more vertical and horizontal stiffeners. The axially arranged main body (13.0) may also be hollow, such that the upstream surface (13.1) consists of substantially a body of water (not shown in the figure).

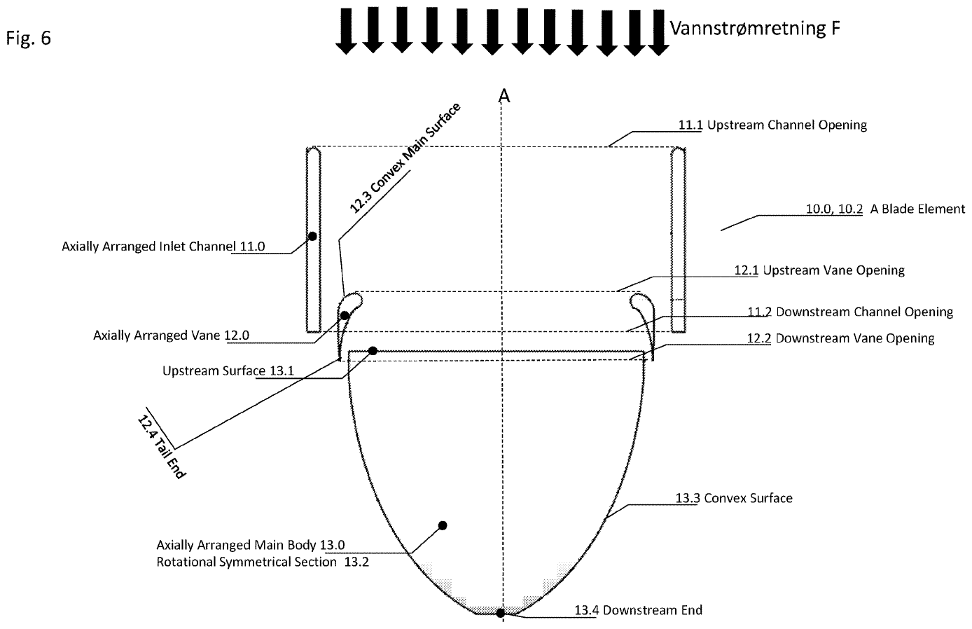

FIG. 6 shows an embodiment, blade element (10), in a cross-section against a water current direction (F). FIG. 6 shows an axially arranged inlet channel (11.0), consisting of two axially arranged plates (which may also be of curved design, not shown on the figure), with an upstream channel opening (11.1), and a downstream channel opening (11.2). FIG. 6 further shows an axially arranged vane (12.0), which comprises two vertical axially arranged vane (12.0) arranged on either side of an axially arranged main body (13.0), arranged with its upstream vane opening (12.1) inside the downstream channel opening (11.2) and with its downstream vane opening (12.2) arranged outside the downstream channel opening (11.2), where a gap opening is provided between the axially arranged inlet channel (11.0) and the axially arranged vane (12.0), so that part of the water flow (F) can flow out between the downstream channel opening (11.2) and the axially arranged vane (12.0). FIG. 6 shows an embodiment of the axially arranged vane (12.0) with a convex main surface (12.3) pointing outwardly from a longitudinal axis (A) and towards the axially arranged inlet channel (11.0) and wherein the axially arranged vane has a tail end (12.4) so that the axially arranged vane (12.0) has a cross-sectional profile like an airfoil. Further, FIG. 6 shows an axially arranged main body (13.0) having an upstream surface (13.1), which is rectangular in nature, and which is arranged within the downstream vane opening (12.2) to form a gap between the axially arranged vane (12.0) and the axially arranged main body (13.0) for portions of the water flow (F) to flow therethrough. FIG. 6 shows the axially arranged main body (13.0) formed with four convex surfaces (13.3) extending from the upstream surface (13.1) to an axially arranged downstream end (13.4). Further, FIG. 6 shows the axially arranged main body (13.0) as a rotationally symmetrical section (13.2), and in this embodiment with rectangular upstream surface (13.1).

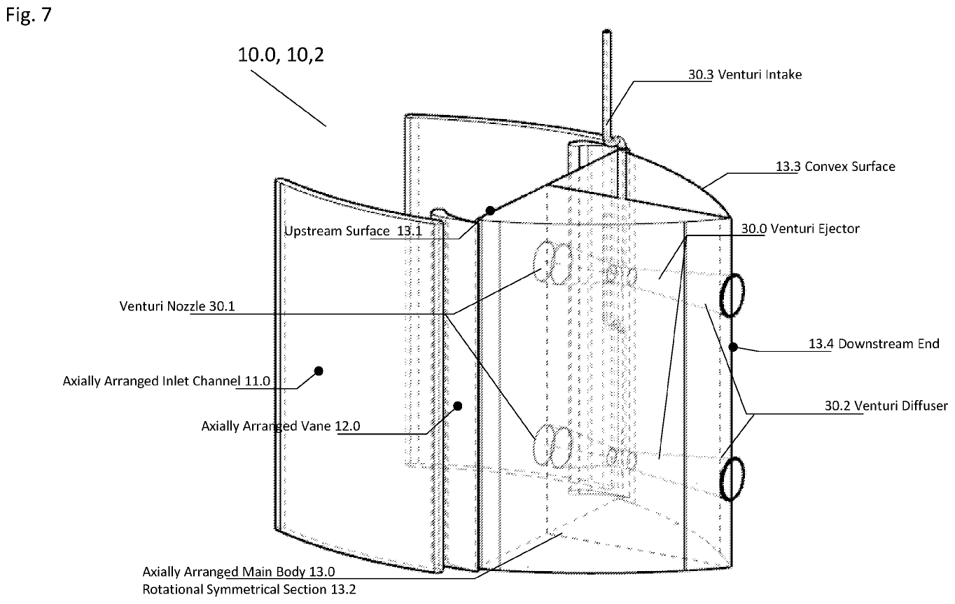

FIG. 7 shows an embodiment with a blade element (10.0) configured as a rectangular blade element (10.2), wherein an axially arranged main body (13.0) is provided with two venturi ejectors (30.0) comprising venturi nozzles (30.1) arranged upstream and venturi diffusers (30.2) arranged downstream, and wherein a venturi intake (30.3) is arranged from the venturi ejectors (30.0) upward to above the water surface for air intake. The venturi intake (30.3) can also be arranged to draw in water from the surroundings around the blade element (10.0). FIG. 7 further shows that the venturi nozzles (30.1) have inlets at an upstream surface (13.1) and the venturi diffusers have outlets at an axially arranged downstream end (13.4). FIG. 7 also shows an embodiment of the axially arranged main body (13.0) with two convex surfaces (13.3) and two straight surfaces extending from the upstream surface (13.1), which is rectangular, to an axially arranged downstream end (13.4). FIG. 7 also shows an axially arranged inlet channel (11.0) comprising two plates and two axially arranged vanes (12.0) vertically disposed on either side of the axially arranged main body (13.0), in a slot opening between the axially arranged inlet channel (11.0), consisting of two plates, and the axially arranged main body (13.0).

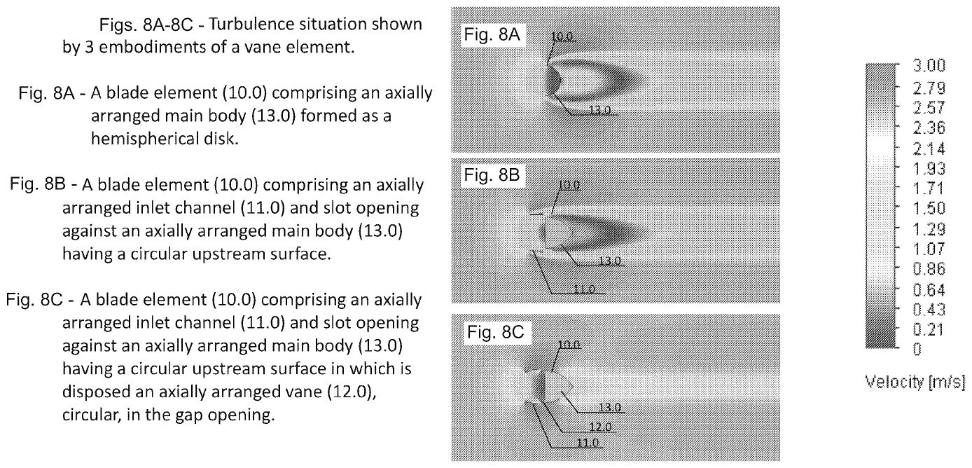

FIGS. 8A-8C show three different embodiments of the blade element (10.0) and how the turbulence situation becomes in a fluid flow directed against them.

FIG. 8A shows a blade element (10.0) comprising an axially arranged main body (13.0) having a hemispherical disk configuration. FIG. 8A shows stagnant fluid on the front of the axially arranged main body (13.0), more concretely inside the disk, giving the blade element itself (10.0) a good drag force. FIG. 8A also shows that there is a significant amount of turbulence behind the axially arranged main body (13.0). Turbulence behind the axially arranged main body (13.0) is unfavourable and results in less fluid flow to the next blade element (10.0), which is disposed in a series of blade elements (10.0) one after the other on an endless chain of an ocean current turbine.

FIG. 8B shows a blade element (10.0) comprising an axially arranged main body (13.0) with an axially arranged inlet channel (11.0), where there is a gap opening between the axially arranged inlet channel (11.0) and the axially arranged main body (13.0). FIG. 8B shows less stagnant fluid than in FIG. 8A on the front of the axially arranged main body (13.0), indicating less drag force. FIG. 8B also shows less turbulence than 8a) behind the axially arranged main body (13.0), which gives an increased fluid flow to the next blade element (10.0), which is arranged in a row of blade elements (10.0) after each other on an endless chain on an ocean current turbine.

FIG. 8C shows a blade element (10.0) for purposes of the invention comprising an axially arranged main body (13.0) with an axially arranged inlet channel (11.0) and an axially arranged vane channel (12.0), wherein there is a gap between the axially arranged inlet channel (11.0) and the axially arranged vane channel (12.0), and that there is a gap between the axially arranged vane channel (12.0) and the axially arranged main body (13.0). FIG. 8C shows more stagnant fluid on the front side of the axially arranged main body (13.0) compared to the previous FIGS. 8A and 8B, which indicates greater drag force. FIG. 8C also shows less turbulence than the preceding FIGS. 8A and 8B behind the axially arranged main body (13.0), which provide an increased fluid flow to the next blade element (10.0), which is arranged in a series of blade elements (10.0) one after the other on an endless chain of an ocean current turbine.

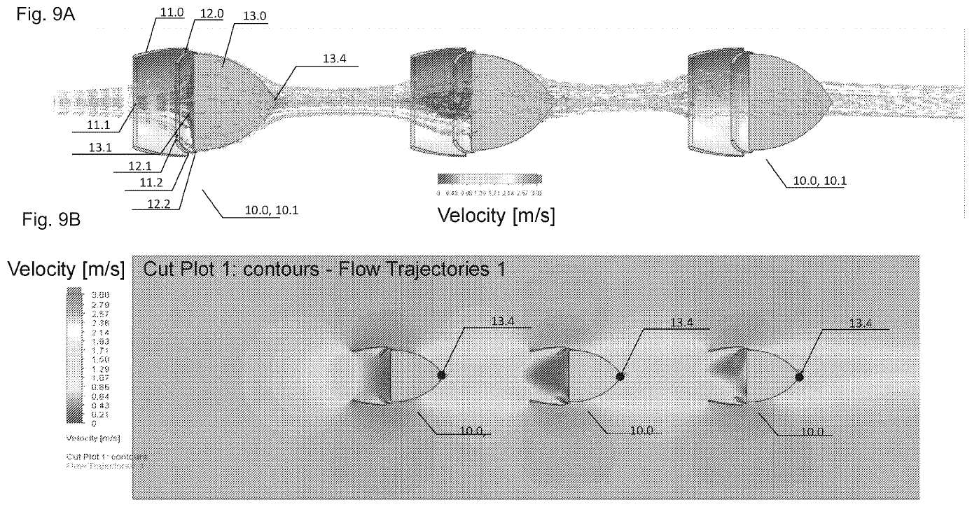

FIGS. 9A and 9B show an embodiment where three blade elements (10.0, 10.1) are simulated in a row in the face of a fluid flow. FIG. 9A shows three blade elements (10.0), each of which comprises an upstream channel opening (11.1) and wherein a fluid flow enters an axially arranged inlet channel (11.0), and wherein portions of the fluid flow continue into an upstream vane opening (12.1) and further through an axially arranged vane (12.0) until the fluid flow impinges on an upstream surface (13.1), and is discharged through a slot opening between the axially arranged vane (12.0) and the upstream surface (13.1) of an axially arranged main body (13.0). The portion of the fluid flow that does not pass through the axially arranged vane (12.0) is discharged through a slot opening between the axially arranged inlet channel (11.0) and the axially arranged vane (12.0). FIG. 9A further shows a model of the fluid flow that attains a higher velocity around and past the axially arranged main body (13.0) compared to the front of the axially arranged main body (13.0). The fluid flow follows the axially arranged main body (13.0) backward toward an axially arranged downstream end (13.4) before it departs from the surface of the axially arranged main body (13.0) and continues towards the next blade element (10.0) in the row.

FIG. 9B shows a plot diagram of a fluid flow moving towards and around the blade elements (10.0) arranged in a row after each other, for example, on an endless chain installed on an ocean current turbine. FIG. 9B shows how the fluid flow increases in velocity around the blade elements (10.0) and indicates minimal stagnant water at the axially arranged downstream end (13.4). The figure shows quieter fluid flow within the axially arranged inlet channel (11.0), the axially arranged vane (12.0) and in front of the upstream face (13.1) than the surroundings.

Reference table

| Note: | Name: | Description: |
|---|---|---|
| A | Longitudinal axis | Main axis through the |
| | | blade element |
| G | Generator | |
| PB | Bow Section | |
| PS | Portside Frame | |
| SS | Starboard Side Frame | |
| PA | Transverse or Pointed Aft Section | The figures show a |
| | | transverse aft section, |
| | | but it can also be |
| | | terminated at a pointed |
| | | end. |
| F | Water flow direction | |
| 0.0 | Main Frame | The actual hull of the |
| | | ocean current turbine. |
| 1.0 | Ocean Current Turbine | |
| 4.1 | Starboard Endless Rotation Chains | |
| 4.2 | Port Endless Rotation Chains | |
| 5.1-4 | Drive Wheels (at least | The wheels are |
| | two hollow per endless | connected to the endless |
| | rotation chain) | rotation chains and |
| | | engage the drive shaft |
| | | which drives the |
| | | generator either directly |
| | | or via any kind of gear. |
| 6.1-4 | Drive Shaft (at least | Drive shaft driven by the |
| | one per drive wheel) | drive wheels and |
| | | connected to one or |
| | | more generators either |
| | | directly or indirectly via |
| | | gear. |
| 7.1 | Starboard Rotation Rail | A rail, functioning as a |
| | | bracket, that holds the |
| | | endless rotation chain |
| | | from the side of the main |
| | | frame. The rail is |
| | | supported in the side |
| | | frame. |
| 7.2 | Port Rotation Rail | A rail, functioning as a |
| | | bracket, that holds the |
| | | endless rotation chain |
| | | from the side of the main |
| | | frame. The rail is |
| | | supported in the side |
| | | frame. |
| 8.1 | Starboard Vertical Bow Vane | |
| 8.2 | Port Vertical Bow Vane | |
| 10.0 | Blade Element | |
| 10.1 | Circular Blade Element | Blade element with |
| | | upstream surface (13.1) |
| | | that is circular |
| 10.2 | Rectangular Blade Element | Blade element with |
| | | upstream surface (13.1) |
| | | that is rectangular |
| 11.0 | Axially Arranged Inlet Channel | |
| 11.1 | Upstream Channel Opening | |
| 11.2 | Downstream Channel Opening | |
| 12.0 | Axially Arranged Vane | |
| 12.1 | Upstream Vane Opening | |
| 12.2 | Downstream Vane Opening | |
| 12.3 | Convex Main Surface | Convex main surface, as |
| | | on an airfoil profile. |
| 12.4 | Tail End | Tail end as on an airfoil |
| | | profile. |
| 13.0 | Axially Arranged Main Body | |
| 13.1 | Upstream Surface | |
| 13.2 | Rotational Symmetrical Section | |
| 13.3 | Convex Surface(s) | |
| 13.4 | Axially Arranged Downstream End | |
| 30.0 | Venturi Ejector | |
| 30.1 | Venturi Nozzle | |
| 30.2 | Venturi Diffuser | |
| 30.3 | Venturi Intake | |

1-10. (canceled)

11. An ocean current turbine blade (10) arranged for use in an ocean current turbine (1), comprising:
an axially arranged inlet channel (11.0) having a central axis (A) and an upstream channel opening (11.1) arranged to face upstream in an operating state, and
at least one axially arranged vane (12.0) with an upstream vane opening (12.1) arranged within a downstream channel opening (11.2) of the inlet channel (11.0),
an axially arranged main body (13.0) having an upstream surface (13.1), arranged within a downstream vane opening (12.2) of the vane (12.0), and having a rotationally symmetrical section (13.2) with one or more convex surfaces (13.3) extending from the upstream surface (13.1) beyond the downstream vane opening (12.2) and toward an axially arranged downstream end (13.4) of the axially arranged main body (13.0).

12. The ocean current turbine blade (10) according to claim 11, wherein
the at least one axially arranged vane (12.0) comprises a vane sleeve, and
the axially arranged main body (13.0) comprises a circular upstream surface.

13. The ocean current turbine blade (10) according to claim 11, wherein
the axially arranged inlet channel (11.0) comprises at least two side surfaces arranged in pairs symmetrically about the central axis (A) and to the side of the axially arranged main body (13.0), and
the axially arranged main body (13.0) comprises a rectangular upstream surface.

14. The ocean current turbine blade (10) according to claim 11, wherein the at least one axially arranged vane (12.0) has a cross-sectional shape like an airfoil arranged with a convex main surface (12.3) positioned outwardly with respect to the central axis (A) and a tail end (12.4) arranged at the downstream vane opening (12.2).

15. The ocean current turbine blade (10) according to claim 12, wherein the at least one axially arranged vane (12.0) has a cross-sectional shape like an airfoil arranged with a convex main surface (12.3) positioned outwardly with respect to the central axis (A) and a tail end (12.4) arranged at the downstream vane opening (12.2).

16. The ocean current turbine blade (10) according to claim 13, wherein the at least one axially arranged vane (12.0) has a cross-sectional shape like an airfoil arranged with a convex main surface (12.3) positioned outwardly with respect to the central axis (A) and a tail end (12.4) arranged at the downstream vane opening (12.2).

17. The ocean current turbine blade (10) according to claim 11, wherein the at least one axially arranged vane (12.0) is arranged with a slot opening against the axially arranged main body (13.0).

18. The ocean current turbine blade (10) according to claim 12, wherein the at least one axially arranged vane (12.0) is arranged with a slot opening against the axially arranged main body (13.0).

19. The ocean current turbine blade (10) according to claim 13, wherein the at least one axially arranged vane (12.0) is arranged with a slot opening against the axially arranged main body (13.0).

20. The ocean current turbine blade (10) according to claim 11, wherein
one or more venturi ejectors (30.0) are axially arranged in the main body (13.0), the one or more venturi ejector (30.0) having a venturi nozzle (30.1) with an inlet in the upstream surface (13.1) of the main body (13.0) and a venturi diffuser (30.2) having an outlet in the axially arranged downstream end (13.4) of the main body (13.0), and a venturi intake (30.3) draws in air or water.

21. The ocean current turbine blade (10) according to claim 12, wherein
one or more venturi ejectors (30.0) are axially arranged in the main body (13.0), the one or more venturi ejector (30.0) having a venturi nozzle (30.1) with an inlet in the upstream surface (13.1) of the main body (13.0) and a venturi diffuser (30.2) having an outlet in the axially arranged downstream end (13.4) of the main body (13.0), and a venturi intake (30.3) draws in air or water.

22. The ocean current turbine blade (10) according to claim 13, wherein
one or more venturi ejectors (30.0) are axially arranged in the main body (13.0), the one or more venturi ejector (30.0) having a venturi nozzle (30.1) with an inlet in the upstream surface (13.1) of the main body (13.0) and a venturi diffuser (30.2) having an outlet in the axially arranged downstream end (13.4) of the main body (13.0), and a venturi intake (30.3) draws in air or water.

23. The ocean current turbine blade (10) according to claim 14, wherein
one or more venturi ejectors (30.0) are axially arranged in the main body (13.0), the one or more venturi ejector (30.0) having a venturi nozzle (30.1) with an inlet in the upstream surface (13.1) of the main body (13.0) and a venturi diffuser (30.2) having an outlet in the axially arranged downstream end (13.4) of the main body (13.0), and a venturi intake (30.3) draws in air or water.

24. The ocean current turbine blade (10) according to claim 17, wherein
one or more venturi ejectors (30.0) are axially arranged in the main body (13.0), the one or more venturi ejector (30.0) having a venturi nozzle (30.1) with an inlet in the upstream surface (13.1) of the main body (13.0) and a venturi diffuser (30.2) having an outlet in the axially arranged downstream end (13.4) of the main body (13.0), and a venturi intake (30.3) draws in air or water.

25. An ocean current turbine (1) for converting the energy of water currents, comprising two or more ocean current turbine blades (10.0) according to claim 11, comprising:
a main frame (0.0) arranged to be partially or completely submerged in a water flow (F) in the sea or in a river and comprising:
(i) a bow section (PB) adapted to face directly against the flow of water (F),
(ii) a starboard endless chain (4.1) and a port endless chain (4.2), each having ocean current blades (10) arranged to be caught at the bow section (PB) and driven rearward by the water flow (F), the starboard and port endless chains (4.1, 4.2) revolving and driving in engagement with one or more driven wheels (5) driving a generator (G), and
(iii) a port side frame (PS) and a starboard side frame (SS), each being continuously convex and extending from a bow section (PB) and rear to a transverse or pointed aft section (PA) at least narrower than a maximum distance between the port side frame (PS) and starboard side frame (SS), wherein
each of the starboard and port endless rotation chain (4.1, 4.2) is provided with the ocean current blades (10), adapted to run along the port and starboard side frames (PS, SS).

26. The ocean current turbine (1) according to claim 25, wherein the starboard endless rotation chain (4.1) is supported by a starboard rotation rail (5.1) on the starboard side of the main frame (0) and the port endless rotation chain (4.2) is supported by a port rotation rail (5.2) on the port side of the main frame (0), such that the ocean current turbine blades (10.0) are driven backward by the water flow (F) alongside the main frame (0.0).

27. The ocean current turbine according to claim 25, wherein the main frame (0.0) comprises at least one vertical port bow vane (8.1) and at least one vertical starboard bow vane (8.2) arranged with airfoil profiles, and with a cross-sectional shape arranged with a convex main surface outward from the bow section (PB) and a trailing end arranged downstream toward the respective starboard and port endless rotation chains (4.1, 4.2).

28. The ocean current turbine (1) according to claim 25, comprising at least 3 ocean current turbine blades (10) in a row on each of the starboard and on the port endless rotation chains (4.1, 4.2).
